(19) United States
(12) Patent Application Publication
(10) Pub. No.: US 2026/0030424 A1
(43) Pub. Date: Jan. 29, 2026

(54) SOFTWARE AND HARDWARE HYBRID SIMULATION METHOD AND APPARATUS, DEVICE, STORAGE MEDIUM, AND PROGRAM PRODUCT

(71) Applicant: Glenfly Tech Co., Ltd., Shanghai (CN)

(72) Inventors: Zheng RONG, Shanghai (CN); Yuan JIANG, Shanghai (CN)

(21) Appl. No.: 19/028,940

(22) Filed: Jan. 17, 2025

(30) Foreign Application Priority Data
Jul. 25, 2024 (CN) 202411013104.6

(51) Int. Cl. G06F 30/3308; G06F 117/08

(52) U.S. Cl. CPC G06F 30/3308; G06F 2117/08

(57) ABSTRACT

The present disclosure relates to a software and hardware hybrid simulation method and apparatus, a computer device, a computer-readable storage medium, and a computer program product. The method includes: acquiring an updated command group from a command buffer, the command group including: parameter configuration; disassembling a task according to the parameter configuration in the updated command group to obtain disassembled tasks; and dispatching, according to different request features, the disassembled tasks to a previous-generation physical chip and a C model for processing, wherein the request features include features that are not changed compared to the previous-generation physical chip and features that are new compared to the previous-generation physical chip. Therefore, a pre-silicon software stack development cycle can be significantly shortened, so that software development activities can be started earlier. By advancing with an architecture C model, software development can cover more application test development scenarios with higher performance requirements and can also be deployed to a local environment, making debugging easier.

### CROSS REFERENCE TO RELATED APPLICATIONS

This application claims priority under 35 U.S.C. § 119 to Chinese Patent Application No. 202411013104.6, filed on Jul. 25, 2024, the entire content of which is incorporated herein in its entirety.

### TECHNICAL FIELD

The present disclosure relates to the field of chip simulation technologies, and in particular, to a software and hardware hybrid simulation method and apparatus, a computer device, a computer-readable storage medium, and a computer program product.

### BACKGROUND

With the development of a software simulation technology, a simulation technology for a chip development process has emerged. In a chip design and development flow, if involvement in development of system drivers and applications is performed earlier, stable and reliable products can be released faster after the release of the chip.

In the conventional art, during software support of certain-generation chip intellectual property (IP, which generally refers to the design of circuit modules with independent functions, and also refers to verified, reusable integrated circuit modules with specific functions in the design of integrated circuits), if it is hoped that earlier start of functional simulation of corresponding driver and application development can be explored, there are two manners of building a simulation environment in pre-silicon: a C model and an emulator.

However, the two manners have unavoidable difficulties when applied to system-level driver and application development testing. Briefly, according to scenarios that the current chip IP is required to cover during driver application development, 1) a Windows hardware lab kit (HLK) test suite, 2) Linux video acceleration API (VAAPI) driver support, and 3) customized applications may be included. For the Windows HLK test suite and the Linux VAAPI driver support, currently only a C-model-based test environment can be built in pre-silicon, which runs excessively slowly. For the customized applications, development, debugging, and verification can be performed in an emulator environment. However, in an early stage of IP research and development, resources of the emulator are very scarce and costly, and are available only after design verification of register transfer level (RTL) circuit code is relatively mature, which limits progress of implementation of the chip design to some extent.

### SUMMARY

Based on this, there is a need to provide, with respect to the above technical problems, a software and hardware hybrid simulation method and apparatus, a computer device, a computer-readable storage medium, and a computer program product that can build a simulation environment with hybrid functions of previous-generation physical hardware and a C model and significantly increase a simulation speed.

In a first aspect, the present disclosure provides a software and hardware hybrid simulation method, including:
acquiring an updated command group from a command buffer, the command group including: parameter configuration;
disassembling a task according to the parameter configuration in the updated command group to obtain disassembled tasks; and
dispatching, according to different request features, the disassembled tasks to a previous-generation physical chip and a C model for processing, wherein the request features include features that are not changed compared to the previous-generation physical chip and features that are new compared to the previous-generation physical chip.

In an embodiment, prior to acquiring the updated command group from the command buffer, the method further includes:
recording relevant information of the command buffer in a register of a graphics processing unit (GPU), the relevant information including: any one or more of a command buffer address, a command buffer size, a current first address pointer, and a current tail address pointer; and
each time a driver requests a hardware operation, writing a command group to the command buffer, and updating a tail pointer register, to trigger a hardware fetch instruction action.

In an embodiment, acquiring the updated command group from the command buffer includes:
monitoring update of the tail pointer register in the command buffer in real time; and
when there is an update to the tail pointer register in the command buffer, intercepting and scanning the command buffer to acquire the updated command group from the command buffer.

In an embodiment, the command group further includes: any one or more of running instructions and synchronization instructions; and
when the command group is the running instructions or the synchronization instructions, the method further includes:
dispatching the running instructions or the synchronization instructions to the C model for processing.

In an embodiment, disassembling the task according to the parameter configuration in the updated command group to obtain the disassembled tasks includes:
disassembling the task into an input task, a processing task, and an output task according to parameters in the updated command group.

In an embodiment, dispatching, according to the different request features, the disassembled tasks to the previous-generation physical chip and the C model for processing includes:
dispatching the input task, the processing task, and the output task respectively to the previous-generation physical chip and/or the C model for processing.

In an embodiment, the method further includes:
modifying the command group in the command buffer after task dispatch is completed.

In a second aspect, the present disclosure further provides a software and hardware hybrid simulation apparatus, including:
a command group acquisition module configured to acquire an updated command group from a command buffer, the command group including: parameter configuration;
a task disassembly module configured to disassemble a task according to the parameter configuration in the updated command group to obtain disassembled tasks; and
a task dispatch module configured to dispatch, according to different request features, the disassembled tasks to a previous-generation physical chip and a C model for processing, wherein the request features include features that are not changed compared to the previous-generation physical chip and features that are new compared to the previous-generation physical chip.

In a third aspect, the present disclosure further provides a computer device, including a memory and a processor, the memory storing a computer program. The processor, when executing the computer program, implements the following steps:
acquiring an updated command group from a command buffer, the command group including: parameter configuration;
disassembling a task according to the parameter configuration in the updated command group to obtain disassembled tasks; and
dispatching, according to different request features, the disassembled tasks to a previous-generation physical chip and a C model for processing, wherein the request features include features that are not changed compared to the previous-generation physical chip and features that are new compared to the previous-generation physical chip.

In a fourth aspect, the present disclosure further provides a computer-readable storage medium, having a computer program stored therein. When the computer program is executed by a processor, the following steps are implemented:
acquiring an updated command group from a command buffer, the command group including: parameter configuration;
disassembling a task according to the parameter configuration in the updated command group to obtain disassembled tasks; and
dispatching, according to different request features, the disassembled tasks to a previous-generation physical chip and a C model for processing, wherein the request features include features that are not changed compared to the previous-generation physical chip and features that are new compared to the previous-generation physical chip.

In a fifth aspect, the present disclosure further provides a computer program product, including a computer program. When the computer program is executed by a processor, the following steps are implemented:
acquiring an updated command group from a command buffer, the command group including: parameter configuration;
disassembling a task according to the parameter configuration in the updated command group to obtain disassembled tasks; and
dispatching, according to different request features, the disassembled tasks to a previous-generation physical chip and a C model for processing, wherein the request features include features that are not changed compared to the previous-generation physical chip and features that are new compared to the previous-generation physical chip.

According to the software and hardware hybrid simulation method and apparatus, computer device, computer-readable storage medium, and computer program product above, an updated command group is acquired from a command buffer, and the command group includes parameter configuration, so as to monitor update of the command group. A task is disassembled according to the parameter configuration in the updated command group to obtain disassembled tasks, so that the task can be disassembled according to the updated command group to facilitate subsequent task dispatch and scheduling and increase a speed of task execution. According to different request features, the disassembled tasks are dispatched to a previous-generation physical chip and a C model for processing. The request features include features that are not changed compared to the previous-generation physical chip and features that are new compared to the previous-generation physical chip. Therefore, the previous-generation physical chip can be fully utilized to transfer some of the unchanged features to run on the previous-generation physical chip to increase a test speed. The new features may be processed by the C model, to achieve rapid reproduction and debugging of the new features. Therefore, a pre-silicon software stack development cycle can be significantly shortened, so that software development activities can be started earlier. By advancing with an architecture C model, software development can cover more application test development scenarios with higher performance requirements and can also be deployed to a local environment, making debugging easier.

### BRIEF DESCRIPTION OF THE DRAWINGS

In order to more clearly illustrate the technical solutions in embodiments of the present disclosure or the related art, the accompanying drawings used in the description of the embodiments or the related art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a schematic flowchart of chip design and development according to an embodiment;

FIG. 2 is a schematic diagram of a pre-silicon driver development environment according to an embodiment;

FIG. 3 is a schematic diagram of a principle of an implementation of a simulation device according to an embodiment;

FIG. 4 is a schematic flowchart of a software and hardware hybrid simulation method according to an embodiment;

FIG. 5 is a schematic diagram of an implementation principle of a command buffer according to an embodiment;

FIG. 6 is a schematic diagram of an entire flow of image processing IP according to an embodiment;

FIG. 7 is a schematic diagram of task disassembly for an input format according to an embodiment;

FIG. 8 is a schematic diagram of task disassembly for image processing features according to an embodiment;

FIG. 9 is a schematic diagram I of task disassembly according to an embodiment;

FIG. 10 is a schematic diagram II of task disassembly according to an embodiment;

FIG. 11 is a schematic flowchart of a software and hardware hybrid simulation method according to another embodiment;

FIG. 12 is a schematic flowchart of command scheduling in a simulation device module according to an embodiment;

FIG. 13 is a structural block diagram of a software and hardware hybrid simulation apparatus according to an embodiment; and

FIG. 14 is a diagram of an internal structure of a computer device according to an embodiment.

### DETAILED DESCRIPTION

In order to make the objectives, technical solutions, and advantages of the present disclosure clearer, the present disclosure will be further described in detail below with reference to the accompanying drawings and embodiments. It should be understood that the specific embodiments described here are only used to explain the present disclosure and are not used to limit the present disclosure.

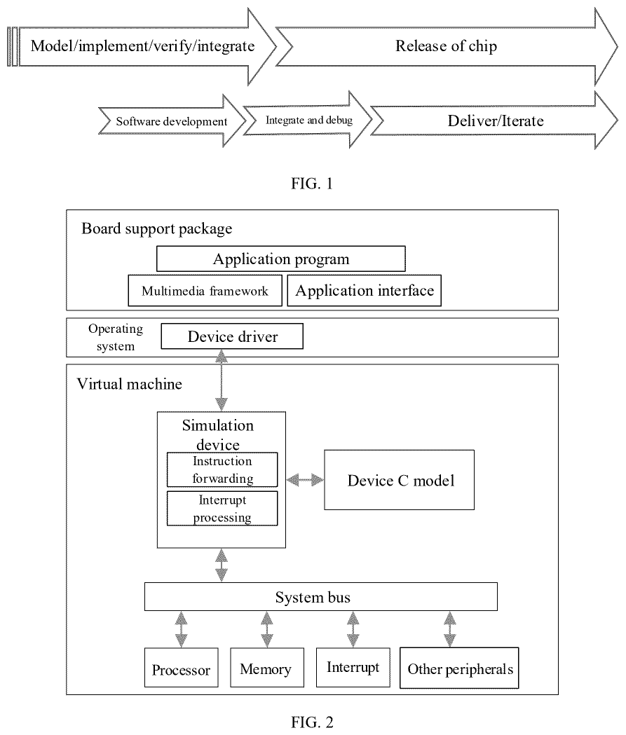

Generally, in a chip design and development process, if a software team gets involved in development of system drivers and applications earlier, stable and reliable products can be released faster after the release of the chip. However, generally, software development activities are limited to a functional simulation environment and can only perform limited iterations before the release of the chip. As a result, most system-level development and debugging work has to wait until the release of the chip. With respect to the problem, according to a software and hardware hybrid simulation method provided in embodiments of the present disclosure, the software development process can be pushed forward, that is, involvement begins in a modeling/implementation/verification/integration stage, which is, for example, applied to the chip design and development process shown in FIG. 1. If complete system-level driver integration and application development are carried out in pre-silicon, a delivery cycle can be greatly shortened after the release of the chip.

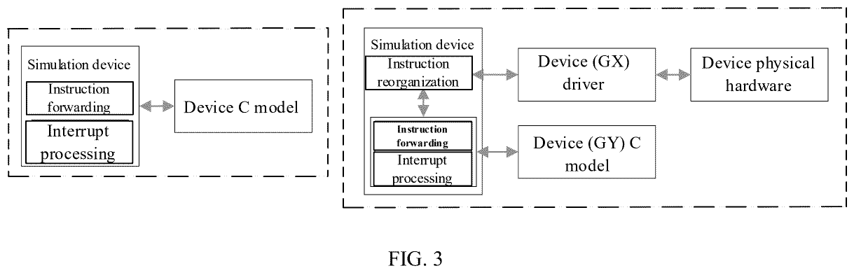

Exemplarily, FIG. 2 is a schematic diagram of a pre-silicon driver development environment. As shown in FIG. 2, drivers and applications are run on a virtual machine, and all requests for virtual hardware are processed through a C model in a virtual machine process. In order to further illustrate a difference between the solution in this embodiment and an existing solution, an implementation of a simulation device is shown in FIG. 3. As shown in FIG. 3, in the existing solution, an instruction dispatch module forwards all access requests from an operating system to the simulation device to a device C model to implement functional simulation, and at the same time, an interrupt processing module implements interrupt simulation. However, in the solution in the embodiments of the present disclosure, an instruction reorganization module is added to forward features, which may be implemented by previous-generation physical hardware, to a physical hardware driver (GX) for implementation and forward new features of a current-generation chip to a current C model (GY) to achieve acceleration. GX represents a physical hardware driver of Generation X IP, and GY represents a C model of Generation Y IP. X and Y are positive integers, and X is a positive integer less than Y.

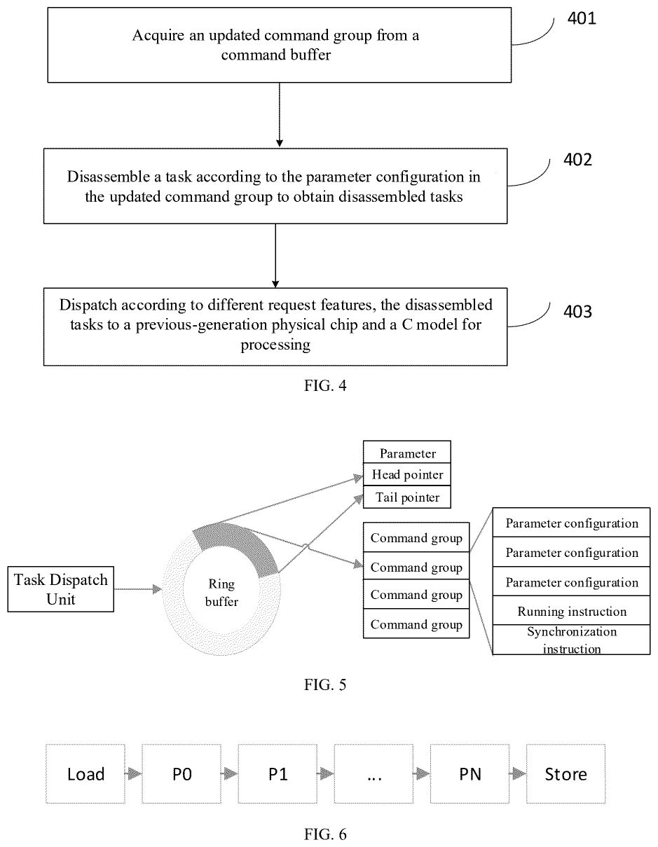

In an exemplary embodiment, as shown in FIG. 4, a software and hardware hybrid simulation method is provided. The method is applied to the development environment shown in FIG. 2. An instruction reorganization module has been added to a virtual machine simulation device. The method may include the following steps.

In step 401, an updated command group is acquired from a command buffer.

An implementation principle of the command buffer in this embodiment is shown in FIG. 5. Firstly, a driver maintains a ring buffer for command, and configures the ring buffer in registers of GPU. Therefore, the updated command group can be acquired from the command buffer.

Exemplarily, the driver fills command groups into the command buffer, and then update the tail register. The tail register update will trigger the GPU to work on the command buffer, the command buffer is intercepted and scanned to acquire the updated command group from the command buffer.

In an optional implementation, prior to implementation of step 401, the relevant information of the command buffer may be recorded in a register of a GPU. The relevant information includes any one or more of a command buffer address, a command buffer size, a current first address pointer, and a current tail address pointer. Each time a driver requests a hardware operation, a command group is written into the command buffer, and a tail pointer register is updated, to trigger a hardware fetch instruction action. Each command group includes all related register configurations for an operation as well as synchronization information.

In another optional implementation, the command group further includes: any one or more of running instructions and synchronization instructions. When the command group is the running instructions or the synchronization instructions, the method further includes: dispatching the running instructions or the synchronization instructions to the C model for processing. As shown in FIG. 3 and FIG. 5, the added instruction reorganization module only dispatchs algorithm tasks with high processor load. The running instructions and the synchronization instructions are still executed by the C model, thereby effectively simplifying the processing process.

In step 402, a task is disassembled according to the parameter configuration in the updated command group to obtain disassembled tasks.

In this embodiment, the task may be disassembled into an input task, a processing task, and an output task according to parameters in the updated command group.

Exemplarily, as shown in FIG. 6, the entire process of image processing IP may be divided into three parts. In the figure, Load represents image loading, which is used to load an input image and load image data into an internal buffer according to a specified format. Store represents image output, which is used to save an output image and write image data to a memory according to a specified format. P0 to PN represent image processing, that is, a pixel processing module, which is used to turn on or off the feature processing module through an enable bit in configuration of the register. Since P0 to PN may include a plurality of different image processing features, P0 to PN may also be split, one part is dispatched to the previous-generation physical chip for processing, and the other part is dispatched to the C model for processing.

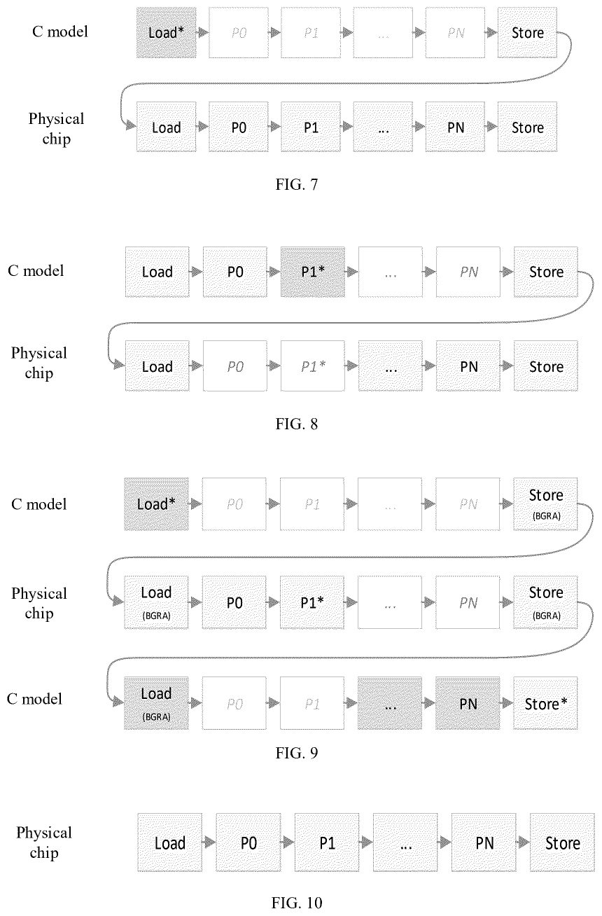

Exemplarily, for an input format, as shown in FIG. 7, if the input format of the task is not a format supported by the previous-generation physical chip, firstly, the format of the input image is converted into a common intermediate image format (such as a BGRA format) through the C model, and then an image loading operation is performed by the previous-generation physical chip. If the input format of the task is a format supported by the previous-generation physical chip, there is no need for the C model to convert the format of the input image, and the previous-generation physical chip directly performs the image loading operation. Referring to FIG. 7, the C model first performs image loading (Load*). Since only the input format is not supported, the input format is converted by the C model herein (a real image loading process is performed by the previous-generation physical chip) and then stored in the memory, and all subsequent steps are performed by the physical chip (Load, P0 to PN, Store).

Exemplarily, for the image processing features, as shown in FIG. 8, the tasks are split and reorganized according to the design of the C model of the current-generation chip and the support of the previous-generation physical chip, and are sent to the C model and the physical chip for processing respectively. If pixel processing modules are all in a pass-through state, the tasks are directly degraded to processing only by the C model. Referring to FIG. 8, the C model first performs image loading and part of image processing (Load, P0, P1*) and stores a processing result in the memory, and all subsequent steps are performed by the physical chip (Load, P2 to PN, Store).

It is to be noted that, for specific features of P0 to PN modules, there is a need to consider whether there is a dependency on the execution sequence and then perform reasonable splitting.

Exemplarily, for an output format, a processing flow thereof is similar to that of the input format. If the output format is not a format supported by the previous-generation physical chip, the processing result may be outputted to a target address through the C model. If the output format is a format supported by the previous-generation physical chip, an image output operation is performed directly by the previous-generation physical chip.

In an optional implementation, if the input format and the output format of the task are not formats supported by the previous-generation physical chip and the task includes image processing features not supported by the previous-generation physical chip, the task is disassembled into a first subtask, a second subtask, and a third subtask. The first subtask is used to indicate that the C model converts the input format to a format supported by the previous-generation physical chip and then the previous-generation physical chip performs an image loading operation. The second subtask is used to indicate that the C model and the previous-generation physical chip perform an image processing operation respectively. The third subtask is used to indicate that the previous-generation physical chip performs an image output operation and then the C model converts a format of an output image.

In this embodiment, according to new features of the current-generation IP design, all tasks may be disassembled into up to three subtasks. For example, when input and output of a task are in formats not supported by the previous-generation physical chip and include image processing features not supported by the previous-generation physical chip, the entire task is required to be split into three parts. As shown in FIG. 9, both the C model and the previous-generation physical chip are involved in the three stages of image loading, image processing, and image output.

It is to be noted that for this more complex situation, a decision may be made according to an actual running scenario to determine whether the task falls back to running entirely on the C model.

In another optional implementation, if the input format of the task is a format supported by the previous-generation physical chip, the output format of the task is not a format supported by the previous-generation physical chip, and the task includes image processing features not supported by the previous-generation physical chip, the task is disassembled into a fourth subtask and a third subtask. The fourth subtask is used to indicate that the image loading and image processing operations are performed by the previous-generation physical chip and then the image processing operation is continued by the C model.

In yet another optional implementation, if the input format of the task is not a format supported by the previous-generation physical chip, the output format of the task is a format supported by the previous-generation physical chip, and the task includes image processing features not supported by the previous-generation physical chip, the task is disassembled into a first subtask and a fifth subtask. The fifth subtask is used to indicate that the C model and the previous-generation physical chip perform the image processing operation respectively and then the previous-generation physical chip performs the image output operation.

In this embodiment, if both the input format and the output format are formats supported by the previous-generation physical hardware, the input format and image processing stages may be combined, or the image processing and image output stages may be combined, to be degraded into two subtasks.

Exemplarily, as shown in FIG. 10, in a fourth optional implementation, if the input format and the output format of the task are formats supported by the previous-generation physical chip and the task does not include image processing features not supported by the previous-generation physical chip, the task is not disassembled and directly serves as a sixth subtask. It is to be noted that the fourth optional implementation is the most common in practical applications.

Therefore, in the manner of making full use of the previous-generation physical chip to disassemble the task of the current command group and then dispatching the tasks to the previous generation-physical chip and/or the C model for processing, a test speed can be greatly increased.

In step 403, according to the different request features, the disassembled tasks are dispatched to the previous-generation physical chip and the C model for processing.

In this embodiment, generally, the request features may be classified into two categories, one of which is features that are not changed compared to the previous-generation physical chip, and the other is features that are new compared to the previous-generation physical chip. The tasks including the unchanged features are dispatched to the previous-generation physical chip for processing, and the tasks including the new features are dispatched to the C model for processing.

Combined with the optional embodiment in step 402, the input task, the processing task, and the output task may be dispatched respectively to the previous-generation physical chip and/or the C model for processing (the dispatch sequence of the execution flows in the tasks is not limited in this embodiment, which may be adjusted according to an actual scenario).

It is to be noted that the specific manner and number of task splitting are not limited in the embodiments of the present disclosure. During task dispatch, the subtask may also be disassembled in more detail (for example, split into stages according to different execution objects), and then dispatched to the previous-generation physical chip and the current-generation C model for processing.

In the above software and hardware hybrid simulation method, an updated command group is acquired from a command buffer, and the command group includes parameter configuration, so as to monitor update of the command group. A task is disassembled according to the parameter configuration in the updated command group to obtain disassembled tasks, so that the task can be disassembled according to the updated command group to facilitate subsequent task dispatch and scheduling and increase a speed of task execution. According to different request features, the disassembled tasks are dispatched to a previous-generation physical chip and a C model for processing. The request features include features that are not changed compared to the previous-generation physical chip and features that are new compared to the previous-generation physical chip. Therefore, the previous-generation physical chip can be fully utilized to transfer some of the unchanged features to run on the previous-generation physical chip to increase a test speed. The new features may be processed by the C model, to achieve rapid reproduction and debugging of the new features. Therefore, a pre-silicon software stack development cycle can be significantly shortened, so that software development activities can be started earlier. By advancing with an architecture C model, software development can cover more application test development scenarios with higher performance requirements and can also be deployed to a local environment, making debugging easier.

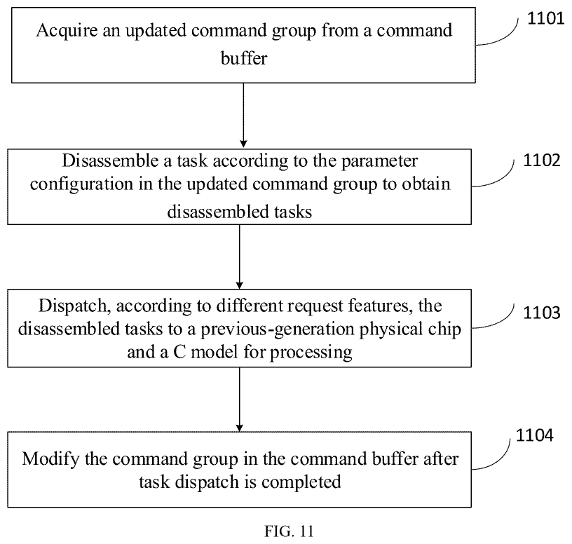

In another exemplary embodiment, as shown in FIG. 11, the method may include the following steps.

In step 1101, an updated command group is acquired from a command buffer.

In step 1102, a task is disassembled according to the parameter configuration in the updated command group to obtain disassembled tasks.

In step 1103, according to the different request features, the disassembled tasks are dispatched to the previous-generation physical chip and the C model for processing.

In this embodiment, for the specific implementation process and technical effects of step 1101 to step 1103, please refer to the relevant description of step 401 to step 403 in the embodiments shown in FIG. 4. Details are not described herein again.

In step 1104, the command group in the command buffer is modified after task dispatch is completed.

In this embodiment, the task is reorganized according to parameter configuration in the command group, analyzed and disassembled, and then dispatched respectively to the previous-generation physical hardware and the current-generation C model for processing. After completion, the results may be written back to the target address. In this case, the command group in the buffer is modified in situ (that is, the channel of the task has been offloaded to the previous-generation physical chip, or the subtask completed in the C model is eliminated), and then an action of updating the tail pointer register is sent to an instruction dispatch module. Therefore, a loop can be realized, to release the cache as quickly as possible to facilitate next detection of update of the command group.

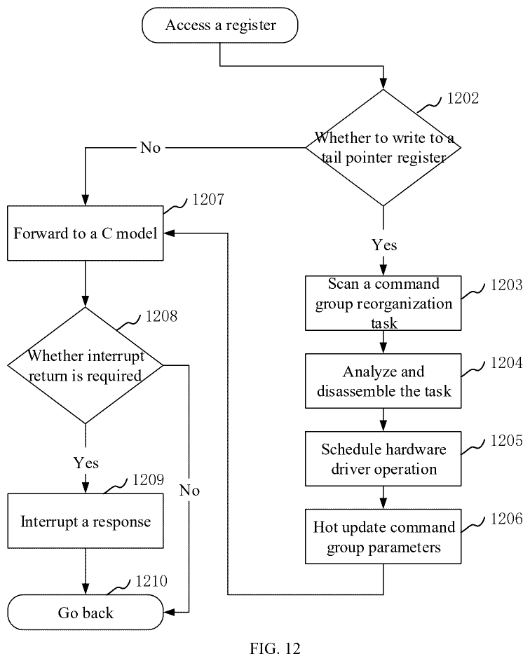

In still another exemplary embodiment, as shown in FIG. 12, a flow of command scheduling in the simulation device module is shown, which may include the following steps.

In step 1201, a register is accessed.

In step 1202, it is determined whether to write to a tail pointer register. If yes, step 1203 is performed. If not, step 1207 is performed.

In step 1203, a command group reorganization task is scanned.

In step 1204, the task is analyzed and disassembled.

In step 1205, a hardware driver is scheduled to run.

In step 1206, command group parameters are hot updated.

In step 1207, forwarding to a C model is performed.

In step 1208, it is determined whether interrupt return is required. If yes, step 1209 is performed. If not, step 1210 is performed.

In step 1209, a response is interrupted.

In step 1210, go back.

In this embodiment, step 1201 to step 1210 are a flow of command scheduling in the simulation device module. Firstly, the register is accessed to determine whether there is an update to the tail pointer register (write to a new tail pointer). If there is an update to the tail pointer register, a hardware fetch instruction action is triggered and the command group is scanned to reorganize a task. The task is disassembled according to the parameter configuration in the command group to obtain disassembled tasks. Then, according to different request features, the disassembled tasks are dispatched to the previous-generation physical chip and the C model for processing (i.e., schedule different hardware drivers). Finally, taking the task dispatched to the C model for processing as an example, the task including the new features is forwarded to the C model, and the subsequent processing process of the C model is consistent with the existing processing flow of the C model. Details are not described herein again.

Exemplarily, in the design of the current-generation chip, new features of IP are as follows.
1) New format support, including support for new input formats and support for new output formats.

The support for new input formats is mainly used in some soft decoding scenarios, which are converted to BGRA through IP and then sent to a display module. For processing tasks with these input formats, task splitting may be performed in the following manners.
a) For the C model, a YV12 (new format example) frame is inputted, and a BGRA frame (only format conversion) is outputted.
b) For the previous-generation physical chip, the BGRA frame is inputted, other features requested by the driver are enabled, including scaling, color adjustment, and the like, and then the BGRA frame is outputted.

The support for new output formats is mainly used in AI or customer-customized scenarios. For processing tasks with these output formats, task splitting may be performed in the following manners.
a) For the previous-generation physical chip, a decoded video frame is inputted, all features requested by the driver are enabled, and the BGRA frame is outputted.
b) For the C model, the BGRA frame is inputted, and a target format requested by the driver (format conversion only) is outputted.
2) Compression support: The current chip has a new compression algorithm for certain (linear) formats, which may be processed according to a new format.
3) Feature support: A new pixel processing module has been added for some scenarios that require image sharpening and noise reduction. For tasks with the feature requests, task splitting may be performed in the following manners.
a) For the previous-generation physical chip, a decoded frame is inputted, modules supported by the previous-generation physical hardware in all features requested by the driver are enabled, and the BGRA frame is outputted.
b) For the C model, the BGRA frame is inputted, modules not processed in all the features requested by the driver are enabled, and the target frame is outputted.

Exemplarily, by use of the method in the above embodiments of the present disclosure, application effects in the foregoing test environment are achieved as follows.

No effect has been achieved temporarily for the Windows HLK test suite. According to evaluation of actual test content of HLK, most can be transferred to the previous-generation physical hardware for running, and the test time can be greatly reduced. New features can also be reproduced and debugged faster.

For Linux VAAPI driver support, similar to Windows HLK, most content can be transferred to the previous-generation physical hardware for running. For the support for new formats, single-frame runtime is also greatly reduced.

Some video frame processing applications with high CPU load (DI), which originally achieves minutes per frame (720×480) in the C-model-based test environment, now can be completely transferred to the physical hardware for processing. Moreover, an output result can be compared with the result of the C model of the current IP through “bit match”, which provides good support for subsequent building of automated test tasks.

For customized applications, for example, a scenario in an application currently being debugged is that a frame of 1080p video is scaled to 360p through IP, the runtime on the C model is 14 s, and after being disassembled and combined into the C model+physical hardware, the runtime is 9 s. The running speed is significantly increased.

Based on the above, according to this embodiment, a pre-silicon software stack development cycle can be significantly shortened, so that software development activities can be started earlier. By advancing with an architecture C model, software development can cover more application test development scenarios with higher performance requirements and can also be deployed to a local environment, making debugging easier.

It should be understood that, although the steps in the flowcharts as referred to in the embodiments described above are shown in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts as referred to in the embodiments described above may include a plurality of steps or a plurality of stages, and such steps or stages are not necessarily performed at a same moment, and may be performed at different moments. The steps or stages are not necessarily performed in sequence, and the steps or stages and at least some of other steps or steps or stages of other steps may be performed in turn or alternately.

Based on the same inventive concept, embodiments of the present disclosure further provide a software and hardware hybrid simulation apparatus configured to implement the software and hardware hybrid simulation method as referred to above. An implementation solution for solving the problems that is provided by the apparatus is similar to the implementation solution of the above method. Therefore, for specific limitations in one or more embodiments of the software and hardware hybrid simulation apparatus provided below, reference may be made to the limitations on the above software and hardware hybrid simulation method. Details are not described herein again.

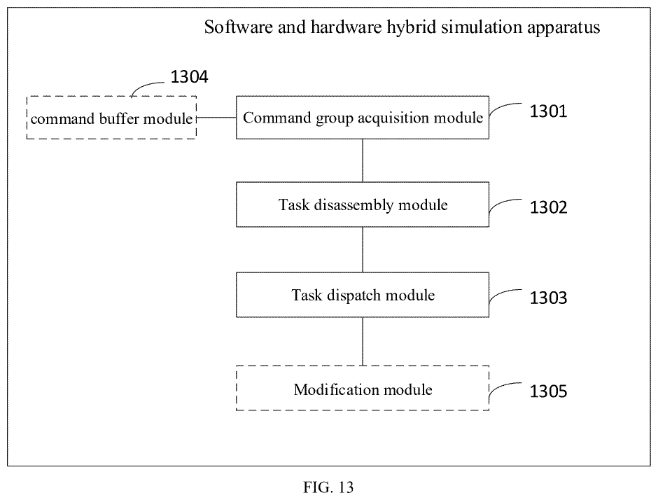

In an exemplary embodiment, as shown in FIG. 13, a software and hardware hybrid simulation apparatus is provided, including: a command group acquisition module 1301, a task disassembly module 1302, and a task dispatch module 1303.

The command group acquisition module 1301 is configured to acquire an updated command group from a command buffer, and the command group includes parameter configuration.

The task disassembly module 1302 is configured to disassemble a task according to the parameter configuration in the updated command group to obtain disassembled tasks.

The task dispatch module 1303 is configured to dispatch, according to different request features, the disassembled tasks to a previous-generation physical chip and a C model for processing. The request features include features that are not changed compared to the previous-generation physical chip and features that are new compared to the previous-generation physical chip.

Exemplarily, the above apparatus may further include: a command buffer module 1304 configured to record relevant information of the command buffer in a register of a GPU before acquiring the updated command group from the command buffer, the relevant information including: any one or more of a command buffer address, a command buffer size, a current first address pointer, and a current tail address pointer, and each time a driver requests a hardware operation, write a command group to the command buffer, and update a tail pointer register, to trigger a hardware fetch instruction action.

Exemplarily, the command group acquisition module 1301 is specifically configured to monitor update of the tail pointer register in the command buffer in real time, and when there is an update to the tail pointer register in the command buffer, intercept and scan the command buffer to acquire the updated command group from the command buffer.

Exemplarily, the command group further includes: any one or more of running instructions and synchronization instructions. When the command group is the running instructions or the synchronization instructions, the task dispatch module 1303 is further configured to:
dispatch the running instructions or the synchronization instructions to the C model for processing.

Exemplarily, the task disassembly module 1302 is specifically configured to disassemble the task into an input task, a processing task, and an output task according to parameters in the updated command group.

Exemplarily, the task dispatch module 1303 is specifically configured to dispatch the input task, the processing task, and the output task respectively to the previous-generation physical chip and/or the C model for processing.

Exemplarily, the above apparatus may further include: a modification module 1305 configured to modify the command group in the command buffer after task dispatch is completed.

The modules in the above software and hardware hybrid simulation apparatus may be implemented entirely or partially by software, hardware, or a combination thereof. The above modules may be built in or independent of a processor of a computer device in a hardware form, or may be stored in a memory of the computer device in a software form, to facilitate the processor to invoke and perform operations corresponding to the above modules.

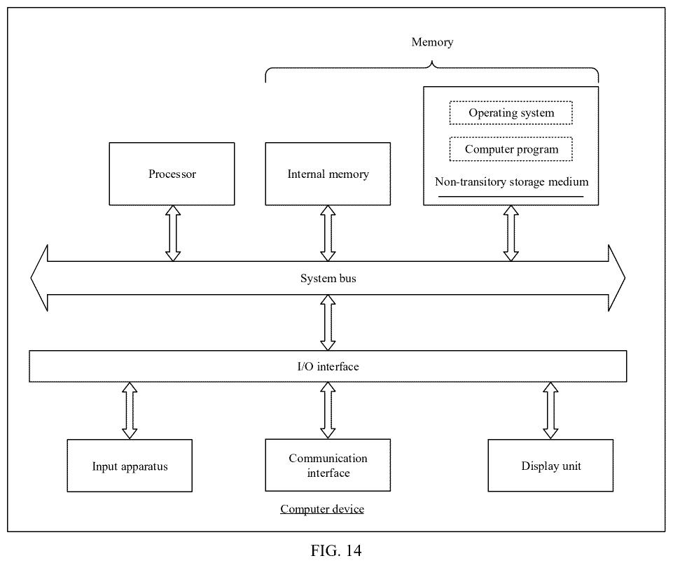

In an exemplary embodiment, a computer device is provided. The computer device may be the above processing device. The processing device may be a terminal or a server. A diagram of an internal structure thereof may be shown in FIG. 14. The computer device includes a processor, a memory, an input/output (I/O) interface, a communication interface, a display unit, and an input apparatus. The processor, the memory, and the I/O interface are connected by a system bus. The communication interface, the display unit, and the input apparatus are connected to the system bus by the I/O interface. The processor of the computer device is configured to provide computing and control capabilities. The memory of the computer device includes a non-transitory storage medium and an internal memory. The non-transitory storage medium stores an operating system and a computer program. The internal memory provides an environment for running of the operating system and the computer program in the non-transitory storage medium. The I/O interface of the computer device is configured to exchange information between the processor and an external device. The communication interface of the computer device is configured to communicate with an external terminal in a wired or wireless manner. The wireless manner may be implemented by WIFI, mobile cellular network, near field communication (NFC), or other technologies. The computer program is executed by the processor to implement a software and hardware hybrid simulation method. The display unit of the computer device is configured to form a visually visible image, and may be a display screen, a projection apparatus, or a virtual reality imaging apparatus. The display screen may be a liquid crystal display screen or an electronic ink display screen. The input apparatus of the computer device may be a touchscreen covering the display screen, or may be a key, a trackball, or a touchpad disposed on a housing of the computer device, or may be an external keyboard, a touchpad, a mouse, or the like.

Those skilled in the art may understand that, the structure shown in FIG. 14 is only a block diagram of a partial structure related to a solution of the present disclosure, which does not constitute a limitation on the computer device to which the solution of the present disclosure is applied. Specifically, the computer device may include more or fewer components than those shown in the figure, or some components may be combined, or a different component deployment may be used.

In an exemplary embodiment, a computer device is provided, including a memory and a processor. The memory stores a computer program. The processor, when executing the computer program, implements the above grayscale compensation data generation method.

In an embodiment, a computer-readable storage medium is provided, having a computer program stored therein. When the computer program is executed by a processor, the above grayscale compensation data generation method is implemented.

In an embodiment, a computer program product is provided, including a computer program. When the computer program is executed by a processor, the above grayscale compensation data generation method is implemented.

It is to be noted that user information (including, but not limited, to user equipment information, user personal information, and the like) and data (including, but not limited to, data for analysis, stored data, displayed data, and the like) involved in the present disclosure are all authorized by the user or information and data fully authorized by all parties, and collection, use and processing of relevant data are required to comply with relevant laws, regulations, and standards of relevant countries and regions.

Those of ordinary skill in the art may understand that all or some of procedures of the method in the foregoing embodiments may be implemented by a computer program instructing relevant hardware. The computer program may be stored in a non-transitory computer-readable storage medium. When the computer program is executed, the procedures of the foregoing method embodiments may be implemented. Any reference to a memory, storage, a database, or another medium used in the embodiments provided the present disclosure may include at least one of a non-transitory memory and a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The transitory memory may include a random access memory (RAM) or an external cache. By way of description and not limitation, the RAM may be in various forms, such as a static random access memory (SRAM), a dynamic random access memory (DRAM), or the like. The database as referred to in the embodiments provided in the present disclosure may include at least one of a relational database and a non-relational database. The non-relational database may include a blockchain-based dispatched database, but is not limited thereto. The processor as referred to in the embodiments provided in the present disclosure may be a general-purpose processor, a central processing unit, a GPU, a digital signal processor, a programmable logic device, a data processing logic device based on quantum computing, an artificial intelligence (AI) processor, or the like, but is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the protection scope of the present disclosure should be subject to the appended claims.

1. A software and hardware hybrid simulation method, comprising:
acquiring an updated command group from a command buffer, the command group comprising: parameter configuration;
disassembling a task according to the parameter configuration in the updated command group to obtain disassembled tasks;
dispatching, according to different request features, the disassembled tasks to a previous-generation physical chip and a C model for processing, wherein the request features comprise features that are not changed compared to the previous-generation physical chip and features that are new compared to the previous-generation physical chip.

2. The method according to claim 1, further comprising: prior to acquiring the updated command group from the command buffer,
recording relevant information of the command buffer in a register of a graphics processing unit (GPU), the relevant information comprising: any one or more of a command buffer address, a command buffer size, a current first address pointer, and a current tail address pointer; and
each time a driver requests a hardware operation, writing a command group to the command buffer, and updating a tail pointer register, to trigger a hardware fetch instruction action.

3. The method according to claim 2, wherein acquiring the updated command group from the command buffer comprises:
monitoring update of the tail pointer register in the command buffer in real time;
when there is an update to the tail pointer register in the command buffer, intercepting and scanning the command buffer to acquire the updated command group from the command buffer.

4. The method according to claim 1, wherein the command group further comprises: any one or more of running instructions and synchronization instructions; and
when the command group is the running instructions or the synchronization instructions, the method further comprises:
dispatching the running instructions or the synchronization instructions to the C model for processing.

5. The method according to claim 1, wherein disassembling the task according to the parameter configuration in the updated command group to obtain the disassembled tasks, comprises:
disassembling the task into an input task, a processing task, and an output task according to parameters in the updated command group.

6. The method according to claim 5, wherein dispatching, according to the different request features, the disassembled tasks to the previous-generation physical chip and the C model for processing, comprises:
dispatching the input task, the processing task, and the output task respectively to the previous-generation physical chip and/or the C model for processing.

7. The method according to claim 1, further comprising:
modifying the command group in the command buffer after task dispatch is completed.

8. A software and hardware hybrid simulation apparatus, comprising:
a command group acquisition module configured to acquire an updated command group from a command buffer, the command group comprising: parameter configuration;
a task disassembly module configured to disassemble a task according to the parameter configuration in the updated command group to obtain disassembled tasks;
a task dispatch module configured to dispatch, according to different request features, the disassembled tasks to a previous-generation physical chip and a C model for processing, wherein the request features comprise features that are not changed compared to the previous-generation physical chip and features that are new compared to the previous-generation physical chip.

9. A computer device, comprising a memory and a processor, the memory storing a computer program, wherein the processor, when executing the computer program, implements steps of the method according to claim 1.

10. A non-transitory computer-readable storage medium, having a computer program stored therein, wherein when the computer program is executed by a processor, steps of the method according to claim 1 are implemented.

11. A computer program product, comprising a computer program, wherein when the computer program is executed by a processor, steps of the method according to claim 1 are implemented.
